(19) United States
(12) Patent Application Publication
(10) Pub. No.: US 2015/0074674 A1
(43) Pub. Date: Mar. 12, 2015

(54) APPARATUS AND METHOD FOR ADJUSTING PRIORITIES OF TASKS

(71) Applicant: Electronics and Telecommunications Research Institute, Daejeon (KR)

(72) Inventors: Yu Seung Ma, Daejeon (KR); Sang Cheol Kim, Daejeon (KR); Duk Kyun Woo, Daejeon (KR); PYEONG SOO MAH, Daejeon (KR); SEON-TAE KIM, Daejeon (KR)

(21) Appl. No.: 14/449,273

(22) Filed: Aug. 1, 2014

(30) Foreign Application Priority Data
Sep. 12, 2013 (KR) 10-2013-0109981

(51) Int. Cl. G06F 9/46

(52) U.S. Cl. CPC G06F 9/46
USPC 718/103

(57) ABSTRACT

An apparatus for adjusting priorities of tasks determines a task violating a real-time constraint using a profiling result of the real-time software and task details including a real-time constraint for each task, adjusts a priority of the task violating the real-time constraint or a higher candidate task close to the task violating the real-time constraint, and simulates execution of the real-time software depending on the adjusted priority.

### CROSS-REFERENCE TO RELATED APPLICATION

This application claims priority to and the benefit of Korean Patent Application No. 10-2013-01 09981 filed in the Korean Intellectual Property Office on Sep. 12, 2013, the entire contents of which are incorporated herein by reference.

### BACKGROUND OF THE INVENTION

(a) Field of the Invention

The present invention relates to an apparatus and a method for adjusting priorities of tasks. More particularly, the present invention relates to an apparatus and a method for adjusting priorities of tasks for real-time software.

(b) Description of the Related Art

Real-time software is software of which a real-time feature that a designated task should be accurately executed at a specified time is important. A main feature of the real-time software, different from general software, is a real-time requirement that execution of a program should be processed at the specified time.

In the real-time software, tasks, which are successive execution unit modules, are operated in parallel with each other, wherein the respective tasks have or do not have real-time constraint conditions imparted thereto. The meaning that the real-time software satisfies the real-time feature is that tasks having a real-time requirement end at the specified time limit as a requirement when tasks configuring the corresponding software are operated in parallel with each other.

Whether or not the real-time software satisfies the real-time feature may be determined through a profiling result obtained after the real-time software is executed. In this case, the profiling result includes creation times and end times for the respective tasks configuring analysis target software. As an analysis result, in the case in which the real-time requirement is not satisfied due to existence of tasks violating the real-time constraint condition, a program should be modified so that a real-time feature of the corresponding software is satisfied. Methods for modifying a program in order to satisfy the real-time feature include a method for modifying implementation in order to improve an execution speed, a method for adjusting a priority of a task, or the like.

According to the conventional art, a real-time feature analyzing system only statically analyzes whether or not target software may satisfy a real-time feature or only determines whether or not a dynamic execution result satisfies a real-time feature. Actually, a process such as a process of designating a priority of a task or the like is required in order to satisfy the real-time feature. However, this process should be performed directly by a user (developer). That is, generally, the user adjusts the priority of the tasks of the software based on background knowledge and then executes the software and confirming the real-time feature. The user repeats the adjusting of the priority of the tasks, executing of the software, and the confirming the real-time feature until the real-time feature is satisfied. However, since this process is not efficient and is based on background knowledge, in the case in which it is performed by an amateur, a high cost is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for adjusting priorities of tasks having advantages of adjusting priorities of tasks so as to satisfy a real-time requirement of real-time software.

An exemplary embodiment of the present invention provides a method for adjusting priorities of tasks of real-time software by an apparatus for adjusting priorities of tasks. The method includes: receiving a profiling result of the real-time software and task details including a real-time constraint for each task; determining a task violating the real-time constraint using the profiling result and the task details; determining a higher candidate task close to the task violating the real-time constraint; adjusting a priority of the task violating the real-time constraint or the higher candidate task close to the task violating the real-time constraint; and simulating execution of the real-time software depending on the adjusted priority.

The method may further include reporting the adjusted priority in a case in which the task violating the real-time constraint satisfies the real-time constraint from a result of the simulation.

The adjusting may include setting the priority of the task violating the real-time constraint to be higher than that of the higher candidate task close to the task violating the real-time constraint.

The adjusting may include setting the priority of the higher candidate task close to the task violating the real-time constraint to be lower than that of the task violating the real-time constraint.

The real-time constraint may include a time limit of each task.

The adjusting may include: extracting a list of associated tasks performed from a creation time of the task violating the real-time constraint to an end time thereof; confirming tasks having a higher priority than that of the task violating the real-time constraint and a time limit longer than that of the task violating the real-time constraint from the list of the associated task; and determining a task having a priority that is the closest to that of the task violating the real-time constraint among the confirmed tasks to be the higher candidate task close to the task violating the real-time constraint.

The method may further include again determining the higher candidate task close to the task violating the real-time constraint to be another task in the case in which the task violating the real-time constraint violates the real-time constraint from a result of the simulation.

Another exemplary embodiment of the present invention provides an apparatus for adjusting priorities of tasks of real-time software operated on a system using a preemptive scheduler. The apparatus includes a profiling result analyzer and a priority adjuster. The profiling result analyzer receives a profiling result of the real-time software from the system, receives task details including a real-time constraint for each task from a user, and determines a task violating a real-time constraint using the profiling result and the task details. The priority adjuster identifies task candidates of which priorities are to be changed in the case in which the task violating the real-time constraint is determined, and adjusts the priorities of the task candidates.

The priority adjuster may include an adjustment candidate analyzer and a scheduling simulator. The adjustment candidate analyzer may determine a higher candidate task close to the task violating the real-time constraint and adjust a priority of the task violating the real-time constraint or the higher candidate task close to the task violating the real-time constraint. The scheduling simulator may simulate execution of the real-time software depending on the adjusted priority and confirm whether or not the task violating the real-time constraint satisfies the real-time constraint.

The scheduling simulator may report the adjusted priority to the user in the case in which the task violating the real-time constraint satisfies the real-time constraint.

The real-time constraint may include a time limit of each task.

The adjustment candidate analyzer may extract tasks having a higher priority than that of the task violating the real-time constraint and a time limit longer than that of the task violating the real-time constraint among tasks in a list of associated tasks performed from a creation time of the task violating the real-time constraint to an end time thereof, and determine a task having a priority that is the closest to that of the task violating the real-time constraint among the extracted tasks to be the higher candidate task close to the task violating the real-time constraint.

The adjustment candidate analyzer may adjust the priority of the task violating the real-time constraint to be higher than that of the higher candidate task close to the task violating the real-time constraint or adjust the priority of the higher candidate task close to the task violating the real-time constraint to be lower than that of the task violating the real-time constraint.

### BRIEF DESCRIPTION OF THE DRAWINGS

FIG. 1 is a drawing showing an example of priorities of tasks that do not satisfy a real-time feature.

FIG. 2 is a drawing showing an example of adjusting priorities of tasks for satisfying a real-time feature of real-time software.

FIG. 3 is a flowchart showing a method for adjusting priorities of tasks according to an exemplary embodiment of the present invention.

FIG. 4 is a drawing showing an apparatus for adjusting priorities of tasks according to an exemplary embodiment of the present invention.

FIG. 5 is a flowchart showing a method for adjusting priorities of tasks by a priority adjuster shown in FIG. 4.

FIG. 6 is a drawing schematically showing an apparatus for adjusting priorities of tasks according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Hereinafter, an apparatus and a method for adjusting priorities of tasks according to an exemplary embodiment of the present invention will be described in detail with reference to the accompanying drawings.

An apparatus for adjusting priorities of tasks according to an exemplary embodiment of the present invention adjusts priorities of tasks in order for real-time software to satisfy a real-time feature in the case in which the real-time software does not satisfy the real-time feature.

Real-time software is operated on a real-time operating system (RTOS) in which a scheduler supporting a real-time feature is operated. The real-time operating system generally uses a preemptive scheduler. The preemptive scheduler may stop a process that is being executed, and allow another task having a higher priority to forcibly occupy a central processing unit (CPU) even though another task is allocated the CPU and is being executed. Therefore, behavior of the real-time software and whether or not the real-time feature is ensured may be changed depending on setting of priorities of the tasks.

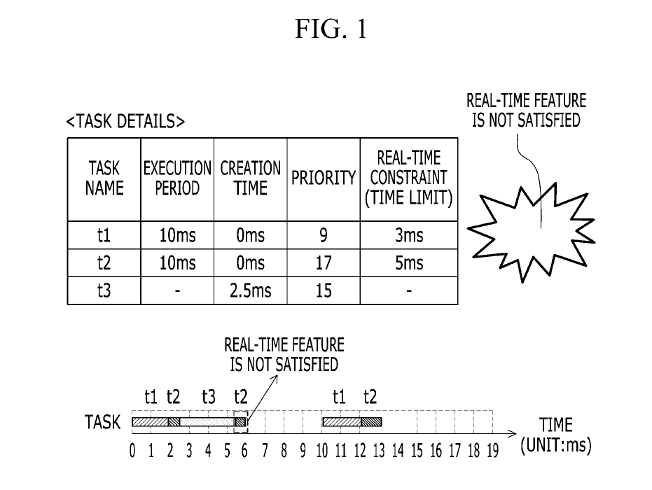

FIG. 1 is a drawing showing an example of priorities of tasks that do not satisfy a real-time feature.

Assume that there is real-time software configured of three tasks t1, t2, and t3 and the tasks t1, t2, and t3 have attributes as shown in FIG. 1.

As shown in FIG. 1, the tasks t1 and t2 are periodic tasks executed every 10 ms. A time limit of the task t1 is 3 ms, a time limit of the task t2 is 5 ms, and both of the two tasks t1 and t2 have a real-time constraint. When it is assumed that priorities become higher as values of the priorities become smaller, the priorities of the tasks t1 to t3 are t1>t3>t2. Therefore, in a system using a preemptive scheduler, the task t1 having the highest priority is executed first. When the task t1 ends within 2 ms, the task t2 that has waited is executed. When it is assumed that the task t3 is created at 2.5 ms at which the task t2 is being executed, the task t3 has a higher priority than that of the task t2, such that execution of the task t2 having a lower priority is stopped and the task t3 is executed before the task t2. When the execution of the task t3 ends, the task t2 that has been stopped is allocated a CPU, such that the rest of the task t2 is processed, and the task t2 ends at 6 ms.

However, since the task t2 ends at 6 ms, a real-time constraint of the task t2 is violated, such that a real-time feature is not ensured.

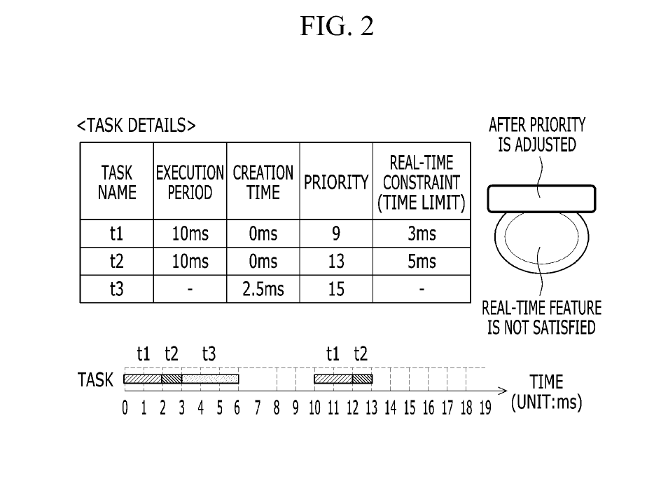

FIG. 2 is a drawing showing an example of adjusting priorities of tasks for satisfying a real-time feature of real-time software.

As shown in FIG. 2, it may be appreciated that when the real-time software is again executed after the priority of the task 2 is adjusted to be 13 higher than that of the task t3, the task t2 may be executed without being stopped by the task t3 to end at 3 ms, such that a real-time feature is satisfied.

As described above, in the case in which the real-time software does not satisfy the real-time feature, the priorities of the tasks t2 and t3 are adjusted, thereby making it possible to allow the real-time software to satisfy the real-time feature.

The apparatus for adjusting priorities of tasks according to an exemplary embodiment of the present invention adjusts the priorities of the tasks as shown in FIG. 2 in the system using the preemptive scheduler, thereby assisting in satisfying the real-time feature.

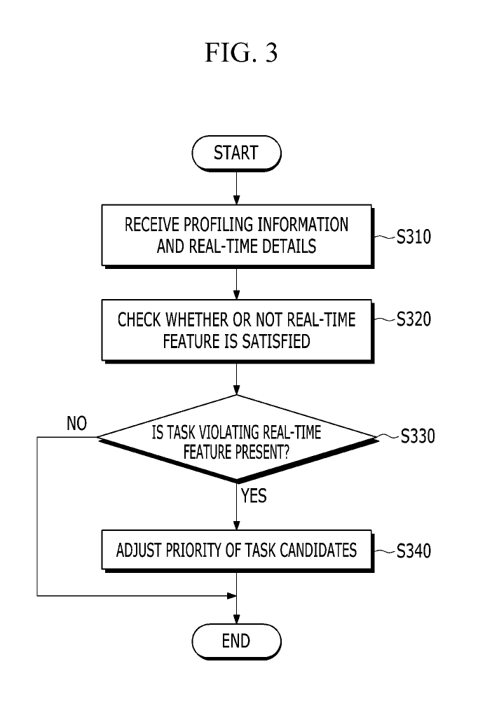

FIG. 3 is a flowchart showing a method for adjusting priorities of tasks according to an exemplary embodiment of the present invention.

Referring to FIG. 3, in the system using the preemptive scheduler, the real-time software is executed and profiling is performed. A profiling result may include information on a context switching time at which a task that is being executed is stopped by another task and is then restarted, as well as information on creation times and end times of the respective tasks of the real-time software.

The apparatus for adjusting priorities of tasks receives profiling information of the real-time software and real-time details including a real-time constraint input by a user (S310). The real-time constraint may include information on a time limit of each task.

The apparatus for adjusting priorities of tasks checks whether or not tasks violating a real-time feature are present, that is, whether or not the real-time software satisfies the real-time feature, using the profiling information and the real-time details of the respective tasks of the real-time software (S320).

The apparatus for adjusting priorities of tasks identifies task candidates of which priorities are to be changed and adjusts the priorities of the task candidates (S340), in the case in which the tasks violating the real-time feature are present (S330). As a method for satisfying the real-time feature, there is also a method for changing a function logic or the like, in addition to a method for adjusting a priority. However, in an exemplary embodiment of the present invention, only the method for adjusting a priority will be considered.

As described above, when the adjustment of the priority ends, the system again executes the real-time software and performs the profiling. In addition, the apparatus for adjusting priorities of tasks confirms whether or not the real-time feature is satisfied from a profiling result and ends the method for adjusting priorities of tasks when the real-time feature is satisfied.

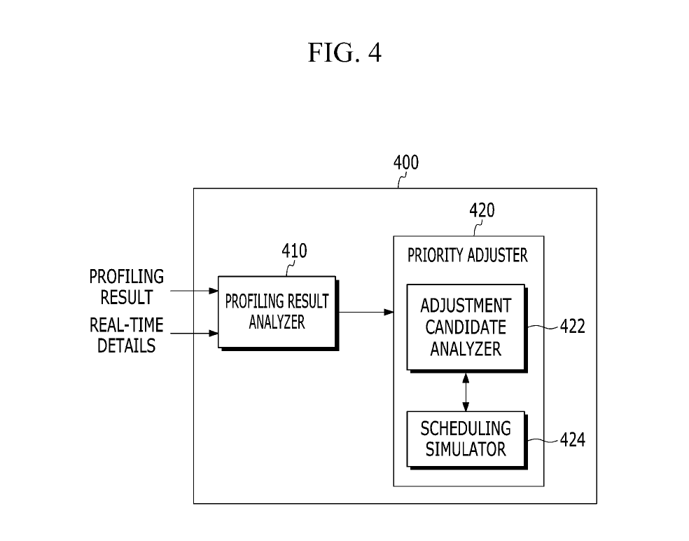

FIG. 4 is a drawing showing an apparatus for adjusting priorities of tasks according to an exemplary embodiment of the present invention.

Referring to FIG. 4, an apparatus 400 for adjusting priorities of tasks is configured to include a profiling result analyzer 410 and a priority adjuster 420.

The profiling result analyzer 410 receives the profiling result of the real-time software from the system and the task details of the real-time software from the user. The profiling result analyzer 410 determines whether or not tasks violating the real-time feature are present, based on the profiling result of the real-time software and the given task details.

The priority adjuster 420 adjusts the priorities of the tasks in order to satisfy the real-time feature in the case in which it is determined by the profiling result analyzer 410 that tasks violating the real-time feature are present.

The priority adjuster 420 includes an adjustment candidate analyzer 422 and a scheduling simulator 424.

The adjustment candidate analyzer 422 identifies task candidates of which priorities are to be changed based on the profiling result and the real-time details using a list of the tasks violating the real-time feature determined by the profiling result analyzer 410, and adjusts the priorities of the task candidates.

The scheduling simulator 424 sets the priority values of the tasks of the real-time software to priority values adjusted by the adjustment candidate analyzer 422, and then performs a scheduling simulation based on the profiling result. Here, the scheduling simulation is performed in the same scheme as a scheme performed by a scheduler used in a real-time operating system (RTOS).

The scheduling simulator 242 reports the priority values adjusted by the adjustment candidate analyzer 422 to the user when the tasks violating the real-time feature satisfy the real-time constraint as a result of the scheduling simulation. In this case, the user may easily modify the software based on the adjusted priority values.

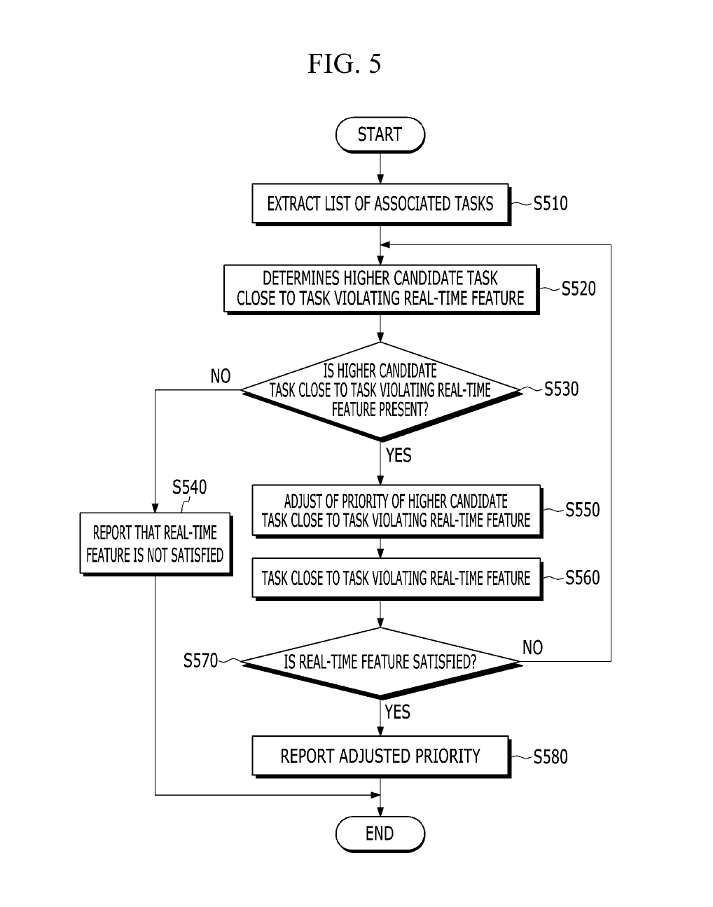

FIG. 5 is a flowchart showing a method for adjusting priorities of tasks by a priority adjuster shown in FIG. 4.

Referring to FIG. 5, the adjustment candidate analyzer 422 extracts a list of associated tasks performed from a creation time of a task tᵢ that does not satisfy the real-time feature to a time at which the task tᵢ ends in the state in which it does not satisfy the priority (S510).

The adjustment candidate analyzer 422 determines a higher candidate task close to the task tᵢ from the list of the associated tasks (S520). The adjustment candidate analyzer 422 confirms whether or not tasks having a priority higher than that of the task tᵢ are present, identifies tasks having a time limit longer than that of the task tᵢ among the tasks having a priority higher than that of the task tᵢ, and determines a task tⱼ of which a priority has the smallest difference from that of the task tᵢ among the tasks having the time limit longer than that of the task tᵢ to be the higher candidate task close to the task tᵢ.

The adjustment candidate analyzer 422 reports the fact that a scenario satisfying the real-time feature may not be provided (S540) to the user, in the case in which the higher candidate task tⱼ close to the task tᵢ is not present (S530).

Meanwhile, the adjustment candidate analyzer 422 adjusts a priority of the higher candidate task tⱼ close to the task tᵢ to be lower than that of the task tᵢ by one step (S550), in the case in which the higher candidate task tⱼ close to the task tᵢ is present (S530). To the contrary, the adjustment candidate analyzer 422 adjusts a priority of the task tᵢ to be higher than that of the higher candidate task tⱼ close to the task tᵢ by one step in the case in which the priority of the higher candidate task tⱼ close to the task tᵢ is not to be changed.

Next, the scheduling simulator 424 performs a task scheduling simulation using the changed priority of the task tⱼ or the task tᵢ (S560). The task scheduling simulation may be performed by profiling data, which is an existing task scheduling result.

The scheduling simulator 424 confirms whether or not the task tᵢ that has not satisfied the real-time feature satisfies the real-time feature (S570) as a result of the task scheduling simulation.

The scheduling simulator 424 maintains the changed priority value of the task tⱼ or the task tᵢ in the case in which the real-time feature is not satisfied, and returns to S530 to again perform a procedure of identifying the higher candidate task tⱼ close to the task tᵢ.

Meanwhile, the scheduling simulator 424 reports the used priority value to the user (S580) in the case in which the real-time feature is satisfied as a result of the task scheduling simulation.

In FIG. 5, a method for adjusting a priority of a task in the case in which the number of tasks violating the real-time constraint is 1 is shown. In the case in which the number of tasks violating the real-time constraint is two or more, the process shown in FIG. 5 may be performed on a task having a higher priority to allow the corresponding task to satisfy the real-time constraint condition, and may then be performed on a task having the next priority.

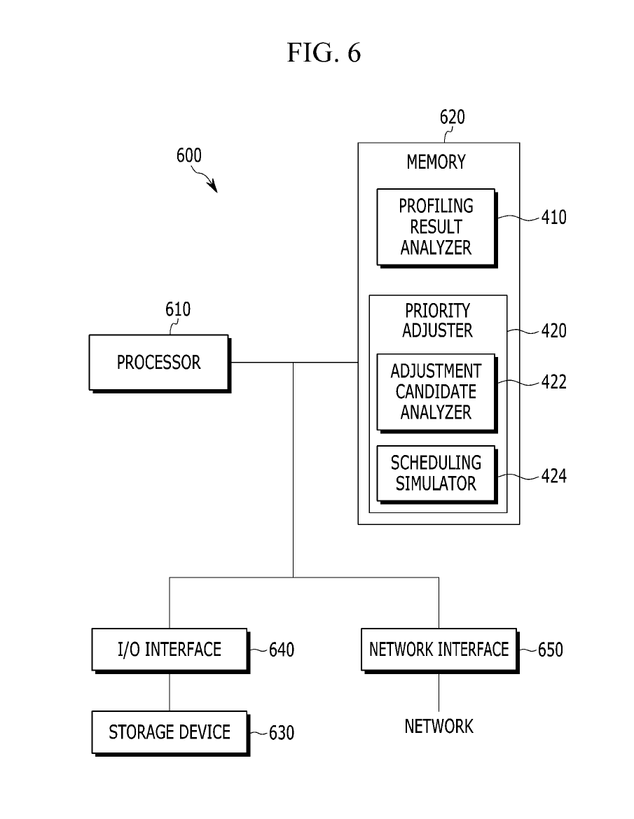

At least some of the functions of the apparatus and the method for adjusting priorities of tasks according to an exemplary embodiment of the present invention described hereinabove may be implemented in hardware or software combined with the hardware. Next, an exemplary embodiment in which the apparatus and the method for adjusting priorities of tasks is combined with a computer system will be described in more detail with reference to FIG. 6.

FIG. 6 is a drawing schematically showing an apparatus for adjusting priorities of tasks according to another exemplary embodiment of the present invention. In FIG. 6, a system that may be used to perform at least some of the functions of the profiling result analyzer 410 and the priority adjuster 420 described with reference to FIGS. 3 to 5 is shown.

Referring to FIG. 6, an apparatus 600 for adjusting priorities of tasks is configured to include a processor 610, a memory 620, a storage device 630, an input/output (I/O) interface 640, and a network interface 650.

The processor 610 may be implemented by a central processing unit (CPU), a chipset, a microprocessor, or the like, and the memory 620 may be implemented by a medium such as a random access memory (RAM), for example, a dynamic random access memory (DRAM), a rambus DRAM (RDRAM), a synchronous DRAM (SDRAM), and a static RAM (SRAM). The storage device 630 may be implemented by a permanent or volatile storage device such as an optical disk, for example, a hard disk, a compact disk read only memory (CD-ROM), a CD rewritable (CD-RW) disk, a digital video disk (DVD) ROM, a DVD-RAM, a DVD-RW disk, a Blu-ray disk, or the like, a flash memory, or a various types of RAM. In addition, the I/O interface 640 may allow the processor 610 and/or the memory 620 to access the storage device 630, and the network interface 650 may allow the processor 610 and/or the memory 620 to access a network.

In this case, the processor 610 may load program instructions for implementing at least some of the functions of the profiling result analyzer 410 and the priority adjuster 420 in the memory 620 to perform a control to execute the operations described with reference to FIGS. 4 and 5. In addition, the program instructions may be stored in the storage device 630 or be stored in another system connected to a network.

The processor 610, the memory 620, the storage device 630, the I/O interface 640, and the network interface 650 shown in FIG. 6 may be implemented in a single computer or be dispersed and implemented in a plurality of computers.

According to exemplary embodiments of the present invention, even in the case in which the software does not satisfy the real-time requirement, an amateur may readily adjust the priority using a value provided by the system.

The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for adjusting priorities of tasks of real-time software by an apparatus for adjusting priorities of tasks, comprising:
receiving a profiling result of the real-time software and task details including a real-time constraint for each task;
determining a task violating the real-time constraint using the profiling result and the task details;
determining a higher candidate task close to the task violating the real-time constraint;
adjusting a priority of the task violating the real-time constraint or the higher candidate task close to the task violating the real-time constraint; and
simulating execution of the real-time software depending on the adjusted priority.

2. The method of claim 1, further comprising
reporting the adjusted priority in a case in which the task violating the real-time constraint satisfies the real-time constraint from a result of the simulation.

3. The method of claim 1, wherein
the adjusting includes setting the priority of the task violating the real-time constraint to be higher than that of the higher candidate task close to the task violating the real-time constraint.

4. The method of claim 1, wherein
the adjusting includes setting the priority of the higher candidate task close to the task violating the real-time constraint to be lower than that of the task violating the real-time constraint.

5. The method of claim 1, wherein the real-time constraint includes a time limit of each task.

6. The method of claim 5, wherein
the adjusting includes:
extracting a list of associated tasks performed from a creation time of the task violating the real-time constraint to an end time thereof;
confirming tasks having a higher priority than that of the task violating the real-time constraint and a time limit longer than that of the task violating the real-time constraint from the list of the associated task; and
determining a task having a priority that is the closest to that of the task violating the real-time constraint among the confirmed tasks to be the higher candidate task close to the task violating the real-time constraint.

7. The method of claim 1, further comprising
reporting that a real-time feature of the real-time software is not satisfied in the case in which the higher candidate task close to the task violating the real-time constraint is not present.

8. The method of claim 1, further comprising
again determining the higher candidate task close to the task violating the real-time constraint to be another task in the case in which the task violating the real-time constraint violates the real-time constraint from a result of the simulation.

9. An apparatus for adjusting priorities of tasks of real-time software operated on a system using a preemptive scheduler, comprising:
a profiling result analyzer receiving a profiling result of the real-time software from the system, receiving task details including a real-time constraint for each task from a user, and determining a task violating a real-time constraint using the profiling result and the task details; and
a priority adjuster identifying task candidates of which priorities are to be changed in the case in which the task violating the real-time constraint is determined and adjusting the priorities of the task candidates.

10. The apparatus of claim 9, wherein
the priority adjuster includes:
an adjustment candidate analyzer determining a higher candidate task close to the task violating the real-time constraint and adjusting a priority of the task violating the real-time constraint or the higher candidate task close to the task violating the real-time constraint; and
a scheduling simulator simulating execution of the real-time software depending on the adjusted priority and confirming whether or not the task violating the real-time constraint satisfies the real-time constraint.

11. The apparatus of claim 10, wherein
the scheduling simulator reports the adjusted priority to the user in the case in which the task violating the real-time constraint satisfies the real-time constraint.

12. The apparatus of claim 10, wherein
the adjustment candidate analyzer reports the fact that a real-time feature of the real-time software is not satisfied in the case in which the higher candidate task close to the task violating the real-time constraint is not present to the user.

13. The apparatus of claim 10, wherein the real-time constraint includes a time limit of each task.

14. The apparatus of claim 13, wherein
the adjustment candidate analyzer extracts tasks having a higher priority than that of the task violating the real-time constraint and a time limit longer than that of the task violating the real-time constraint among tasks in a list of associated tasks performed from a creation time of the task violating the real-time constraint to an end time thereof, and determines a task having a priority that is the closest to that of the task violating the real-time constraint among the extracted tasks to be the higher candidate task close to the task violating the real-time constraint.

15. The apparatus of claim 14, wherein
the adjustment candidate analyzer adjusts the priority of the task violating the real-time constraint to be higher than that of the higher candidate task close to the task violating the real-time constraint or adjusts the priority of the higher candidate task close to the task violating the real-time constraint to be lower than that of the task violating the real-time constraint.
